(19) United States
(12) Patent Application Publication
(10) Pub. No.: US 2009/0260253 A1
(43) Pub. Date: Oct. 22, 2009

(54) Apparatus and method of drying using a gas separation membrane

(76) Inventors: Keith A. Roberts, White Bear Lake, MN (US); Ryan Hoitink, St. Paul, MN (US); Michael Spearman, The Woodlands, TX (US)

Correspondence Address: DINSMORE & SHOHL LLP, 1900 CHEMED CENTER, 255 EAST FIFTH STREET, CINCINNATI, OH, 45202, US

(21) Appl. No.: 12/426,147

(22) Filed: Apr. 17, 2009

Related U.S. Application Data
(60) Provisional application No. 61/045,711, filed on Apr. 17, 2008.
(60) Provisional application No. 61/047,898, filed on Apr. 25, 2008.

(51) Int. Cl. F26B 5/06; F26B 21/00

(52) U.S. Cl. 34/287; 34/298; 34/92

(57) ABSTRACT

An membrane drying system comprising: a chamber, a vacuum pump, a sweep gas source, and a membrane device, wherein the membrane device comprises a membrane, a first inlet in fluid communication with the chamber and the membrane, a first outlet in fluid communication with the membrane and the vacuum pump, a second inlet in fluid communication with the sweep gas source and the membrane, and a second outlet in fluid communication with the membrane.

### CROSS REFERENCE TO RELATED APPLICATIONS

This application claims the benefit of provisional patent application Ser. No. 61/045,711, filed Apr. 17, 2008, by the present inventors, and Ser. No. 61/047,898, filed Apr. 25, 2008, by the present inventors.

### TECHNICAL FIELD

The present invention relates generally to an apparatus and method of drying, specifically to an apparatus and method of freeze drying that utilizes membranes.

### BACKGROUND OF THE INVENTION

Drying is the process by which water or other solvents are removed from a product. Freeze drying (lyophilization) is the process by which low pressure and low temperature is used to evaporate solvents from on or within a product via sublimation, thereby skipping the liquid phase and leaving the solids behind without collapsing the product. Some of the disadvantages of freeze drying via conventional means are limited batch capacity, potential product defects, inability to obtain a preferred physical form, high cost, and long processing or cycling times.

There is a need in the industry to reduce or eliminate the disadvantages associated with conventional means of freeze drying.

### SUMMARY OF THE INVENTION

Accordingly, the present invention provides an apparatus and method for drying. In one exemplary embodiment, the present invention is directed to an apparatus and method of freeze drying.

In one exemplary embodiment, there exists a membrane drying system comprising: a chamber, a vacuum pump, a sweep gas source, and a membrane device comprising a membrane, a first inlet in fluid communication with the chamber and the membrane, a first outlet in fluid communication with the membrane and the vacuum pump, a second inlet in fluid communication with the sweep gas source and the membrane, and a second outlet in fluid communication with the membrane.

In another exemplary embodiment, there exists a method of drying comprising the steps of: reducing the pressure surrounding a product within a chamber, drawing a chamber gas into a membrane device, feeding a sweep gas through a membrane device, exhausting the sweep gas from the membrane device, exhausting the chamber gas from the membrane device, and warming the product.

In another exemplary embodiment, there exists an apparatus for drying comprising: a chamber, a vacuum pump, a sweep gas source, and a membrane device comprising a membrane, a first inlet in fluid communication with the chamber and the membrane through which gas from the chamber enters the membrane, a first outlet in fluid communication with the membrane and the vacuum pump through which gas from the chamber exits the membrane into the vacuum pump, a second inlet in fluid communication with the sweep gas source and the membrane for directing sweep gas into the membrane, and a second outlet in fluid communication with the membrane for directing the sweep gas out of the membrane.

### BRIEF DESCRIPTION OF THE DRAWINGS

While the specification concludes with claims particularly pointing out and distinctly claiming the present invention, it is believed that the same will be better understood from the following description taken in conjunction with the accompanied drawings in which:

FIGS. 1A and 1B are schematic representations of an exemplary membrane drying system according to an embodiment of the present invention;

FIGS. 2A and 2B are schematic representations of an exemplary membrane drying system according to an embodiment of the present invention;

FIG. 3 is a cross-sectional view of an exemplary membrane drying system according to an embodiment of the present invention; and

FIG. 4 is a schematic representation of an exemplary method of freeze drying according to an embodiment of the present invention.

### DETAILED DESCRIPTION

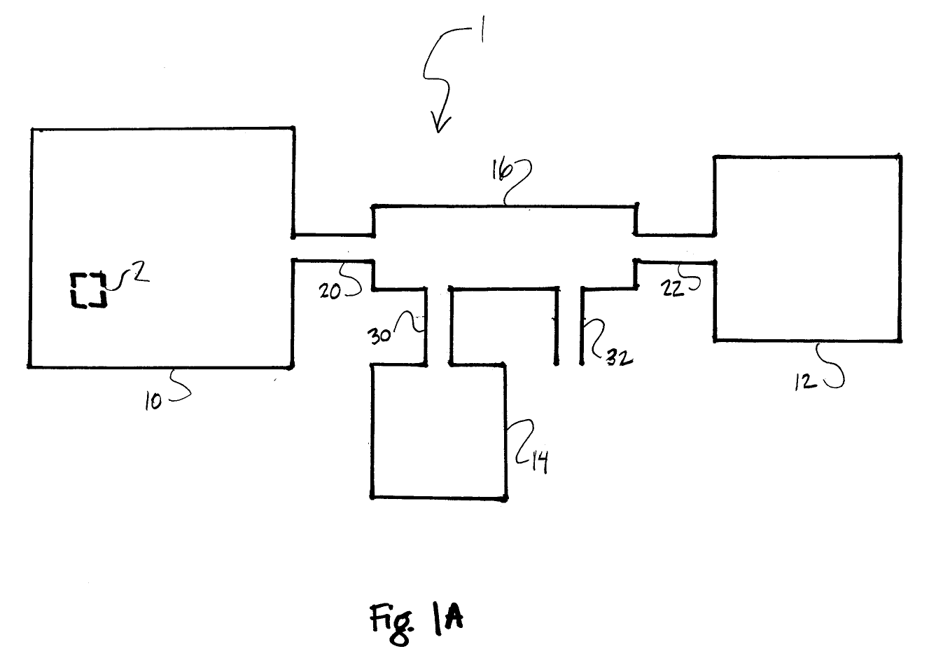

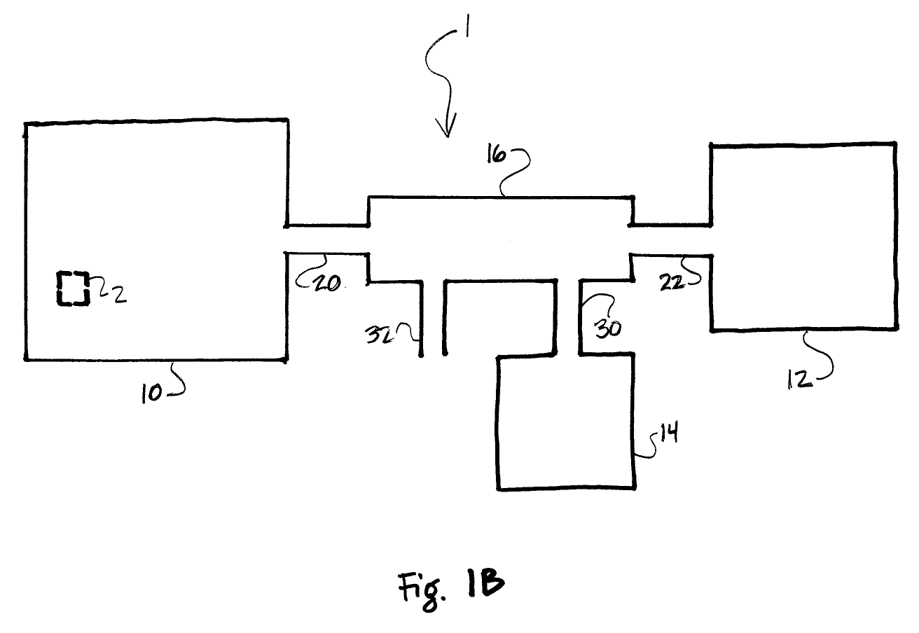

Exemplary embodiments of an apparatus and method for drying are hereinafter described in detail in connection with the views and examples of FIGS. 1A, 1B, 2A, 2B, 3, and 4, wherein like numbers indicate the same or corresponding elements throughout the views.

An exemplary embodiment of a membrane drying system 1 is illustrated in FIG. 1A. A chamber 10 may be connected to and in fluid communication with a membrane 16 via a conduit 20. Membrane types may be shell-encased, wrapped, pleated, or constructed of hollow fibers. A vacuum pump 12 may be connected to the membrane 16 at an end of the membrane opposite to the chamber using a conduit 22, placing the membrane in fluid communication with the vacuum pump. A sweep gas source 14 may be connected to the membrane 16 using a conduit 30, also placing the sweep gas source in fluid communication with the membrane 16.

Conventional sweep gas sources may include, but need not be limited to, compressed air dryers or a dry gas cylinders. In one exemplary embodiment, for the membrane drying system 1 to effectively function, the sweep gas need only have a lower dewpoint than that of the gas in the chamber 10. The membrane 16, in other exemplary embodiments, may be further connected to a vent, another apparatus, or open to the atmosphere using any variety of known or yet-to-be developed devices/methods. In one exemplary embodiment, the membrane 16 may be connected to and in fluid communication with a conduit 32 that may be connected to a vent, another apparatus, or open to the atmosphere as shown in FIG. 1A.

FIG. 1B shows an alternative embodiment of a membrane drying system 1 shown in FIG. 1A, wherein the positions along the membrane 16 of the conduit 30 (with the sweep gas source 14 attached) and the conduit 32 may be switched.

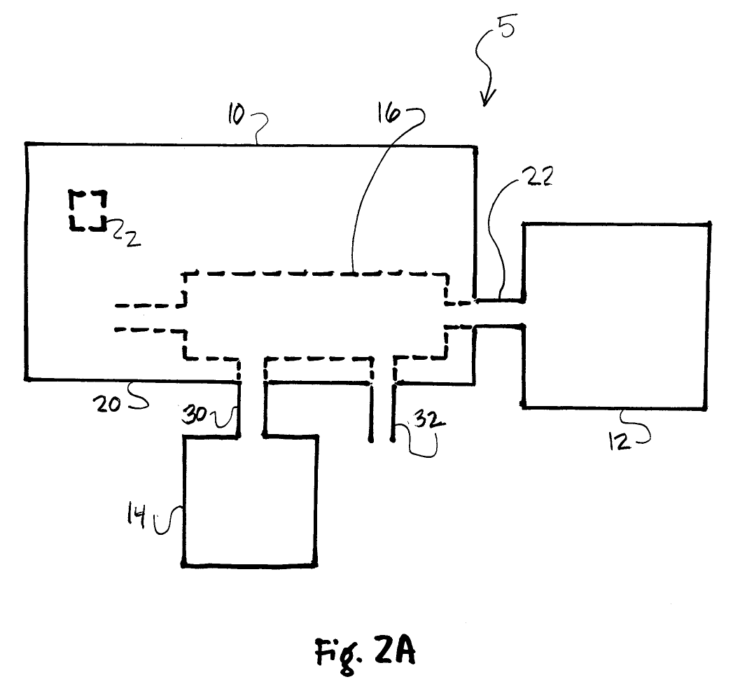

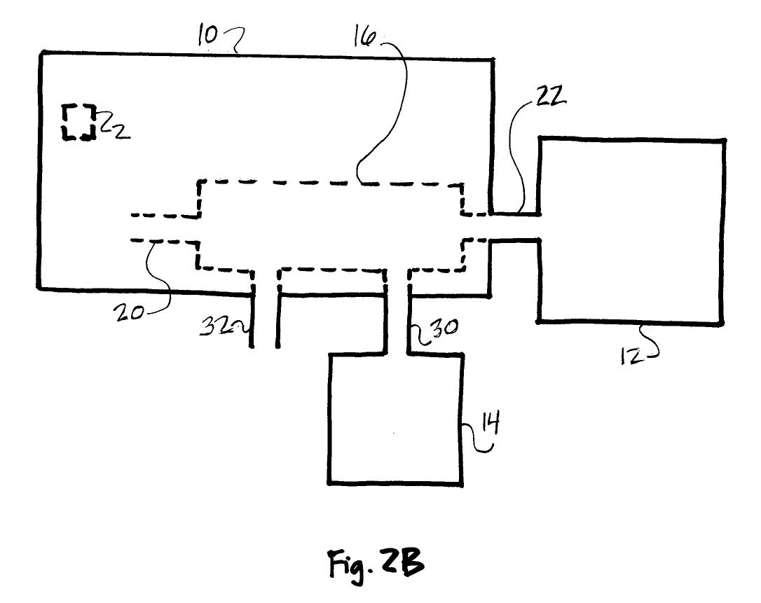

Another exemplary embodiment of a membrane drying system 5 is illustrated in FIG. 2A. The components of the membrane drying system 5 are the same as those of the membrane drying system 1 of FIGS. 1A and 1B. However, in this embodiment, the membrane 16 may now be disposed within the chamber 10. FIG. 2B shows an alternative embodiment of the membrane drying system 5 shown in FIG. 2A, wherein the positions along the membrane 16 of the conduit 30 (with the sweep gas source 14 attached) and conduit 32 may be switched.

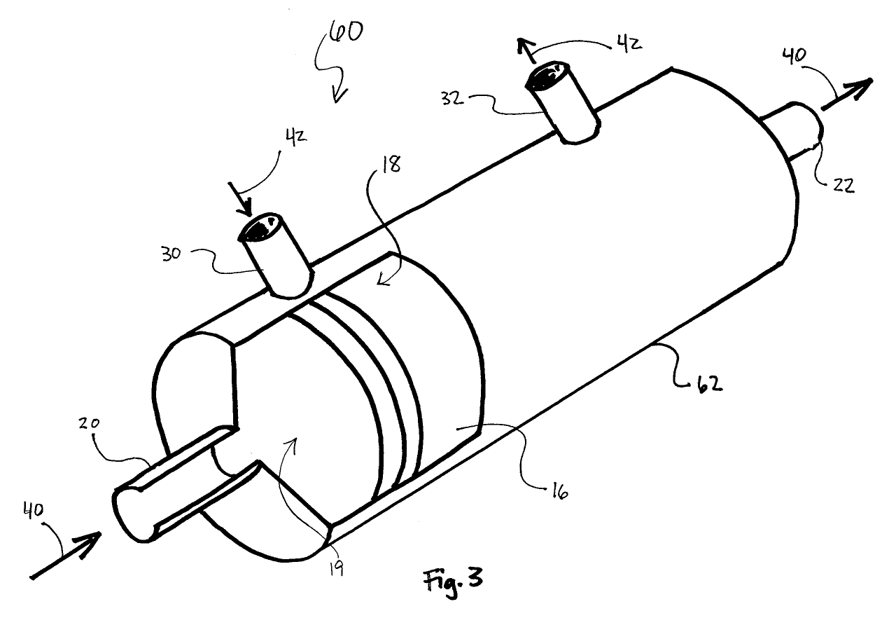

Additionally, in all the exemplary embodiments shown and described herein, the membrane 16 may include a chamber gas side 19 and a sweep gas side 18 as illustrated in FIG. 3. Moreover, although the exemplary embodiments shown and described herein have been illustrated with conduits connecting and placing the different components of the membrane drying systems in fluid communication with each other, it is understood that a variety of devices and or methods of connections may be used, including but not limited to directly connecting the components together without an intervening conduit, etc.

In operation, a frozen product or a moist gas (e.g., product 2 shown in FIGS. 1A, 1B, 2A, and 2B) may be disposed within the chamber 10. The vacuum pump 12 may then be actuated, drawing gas from the chamber 10 through the conduit 20, the membrane 16, and the conduit 22, into the vacuum pump in order to reduce the pressure within the chamber 10 and thus around the product 2. In one exemplary embodiment, the conduit 32 (or a vent if directly connected to the membrane 16) may include one or more valves such as a one way valve (e.g., a check valve) to prevent gas from being drawn into the membrane 16 when reducing the pressure within the chamber 10, but to still permit gas to exit the membrane 16. In another exemplary embodiment, the conduit 30 and/or the sweep gas source 14 may include one or more valves to also prevent gas from being drawn into the membrane 16 when reducing the pressure within the chamber 10, but to still permit sweep gas to enter the membrane when desired. The sweep gas source 14 may then be actuated and may continuously direct sweep gas into the conduit 30, through the membrane 16, and through the conduit 32.

The sweep gas may have a lower dewpoint than the gas on the opposite side of the membrane 16 and in the chamber 10. A continuous flow of sweep gas through the membrane 16 maintains a lower solvent concentration on the sweep gas side (e.g., sweep gas side 18 shown in FIG. 3) of the membrane than on the chamber gas side (e.g., chamber gas side 19 shown in FIG. 3). As a result, solvents that are contained within the chamber gas that are drawn into the membrane 16 by the vacuum pump 12 diffuse through the membrane to the lower solvent concentration that exists on the sweep gas side of the membrane. The continuous flow of sweep gas through the membrane 16 carries those solvents out of the membrane via the conduit 32. In FIGS. 1A and 2A, the sweep gas is fed in a direction that is concurrent with the direction of flow of gas from the chamber 10. As shown in FIGS. 1A and 2A, the chamber gas flows from the chamber 10 through the membrane 16 to the vacuum pump 12. As such, in these exemplary embodiments, sweep gas is fed in a direction that is concurrent to the direction of flow of the chamber gas. In FIGS. 1B and 2B, the chamber gas also flows from the chamber 10 through the membrane 16 to the vacuum pump 12. However, in these exemplary embodiments, sweep gas is fed in a direction that is countercurrent to the direction of flow of the chamber gas.

The exemplary membrane drying systems efficiently transport solvents out of the chamber and are generally as efficient in hour 24 as the systems are in hour 1 of operation. Additionally, the freeze drying cycle of the exemplary membrane drying systems will be several hours shorter than that required by refrigerated condensing systems because the membrane drying systems do not require any thawing cycles. For those reasons, the drying systems when configured for freeze drying are more efficient than refrigerated condensing systems, and the freeze drying cycles and the costs associated with freeze drying can be substantially reduced.

In another exemplary embodiment of the membrane drying system, a filter or gas filtration system may be added at or to the membrane drying system at the conduit 20, the conduit 22, the conduit 30, the conduit 32, or any combination thereof. The filter or gas filtration system may allow the membrane drying system to capture contaminants and particles that might otherwise contaminate the membrane 16 or the vacuum pump 12.

In another exemplary embodiment of the membrane drying system, a mechanism of scrubbing solvents may be added to the system. Such a mechanism could be used to remove trace or remaining solvents that are not captured in the sweep gas prior to such solvents entering the vacuum pump 12. Exemplary scrubbing mechanisms may include, but are not limited to, activated carbon beds, activated alumina, hopcalite, silica gel beds, refrigerated coils, any other conventional and yet-to-be developed scrubbing technology, and/or any combination thereof.

In another exemplary embodiment of the membrane drying system, a layer or layers of composites may be added to the membrane 16. The added composite layer(s) may affect the permeability of the membrane materials to specific gases and can improve the efficiency of the diffusion of gas across the membrane.

In another exemplary embodiment of the apparatus, shelves may be added to the chamber 10, upon which the product (e.g., product 2) that is being dried may be placed.

In another exemplary embodiment of the membrane drying system, the chamber 10 may be connected to or may incorporate a freezer or other freezing mechanism for freezing the interior of the chamber and/or a product therein. Exemplary freezers include any conventional and yet-to-be developed freezers or freezing mechanisms, and/or any combination thereof.

In another exemplary embodiment of the membrane drying system, the chamber 10 may be connected to or may incorporate a heater or other heating mechanism for heating and/or warming the interior of the chamber and/or a product therein. Exemplary heaters include any conventional and yet-to-be developed heaters or heating mechanisms, and/or any combination thereof.

In another exemplary embodiment of the membrane drying system, the chamber 10 may be connected in fluid communication with a source of moist gas. The membrane drying system may be used to dry moist gas in the same manner in which it can be used to dry or freeze dry solid objects. As used herein, moist gas is defined as any gas that has a dewpoint that is higher than that of the sweep gas.

FIG. 3 illustrates an exemplary embodiment of a membrane device 60. The membrane device 60 may comprise a housing 62 and a membrane 16 disposed within the housing. It is understood that the membrane 16 may partially fill the internal space of the housing and/or completely fill the internal space of the housing. In addition the membrane device 60 may comprise four conduits: a first conduit 20; a second conduit 22; a third conduit 30, and a fourth conduit 32. The first conduit 20 places the membrane 16 in fluid communication with a chamber (not shown). The second conduit 22 places the membrane 16 in fluid communication with a vacuum pump (not shown). The third conduit 30 places the membrane 16 in fluid communication with a sweep gas source (not shown). The fourth conduit 32 places the membrane 16 in fluid communication with a vent, an apparatus, or the atmosphere. With respect to the membrane 16, the first conduit 20 and the third conduit 30 function as inlets while the second conduit 22 and the fourth conduit 32 function as outlets. When the vacuum pump is actuated, chamber gas 40 is drawn through the first conduit 20, through the membrane 16, and through the second conduit 22. When the sweep gas source is actuated, sweep gas 42 is directed into the third conduit 30, through the membrane 16, and through the fourth conduit 32, exiting the membrane 16. Because the sweep gas 42 is of a lower dewpoint than the chamber gas 40, solvents diffuse from the chamber gas across the membrane 16 and into to sweep gas. At the fourth conduit 32, the sweep gas 42, now containing diffused solvents, is exhausted from the membrane 16. At the second conduit 22, the chamber gas 40, having lost most, if not, all of its solvents, enters the vacuum pump.

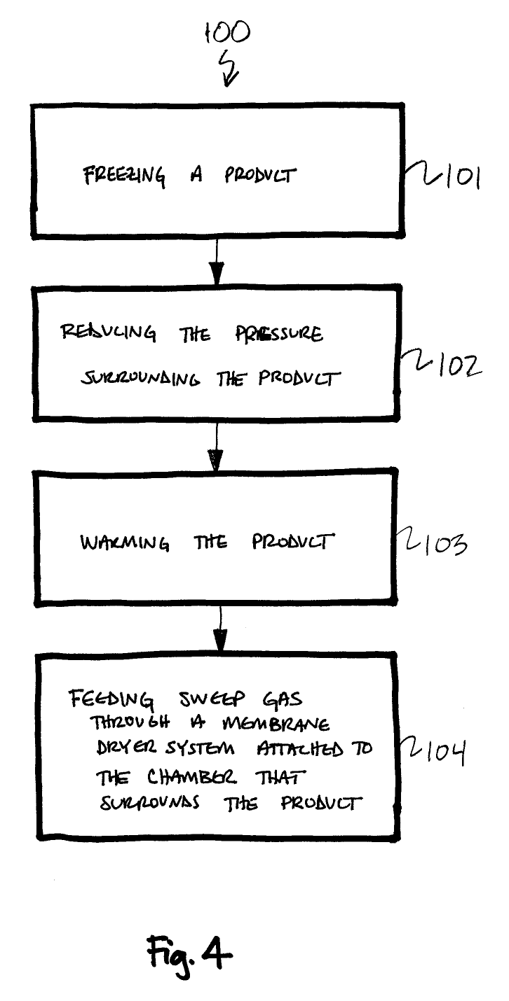

FIG. 4 depicts a flow chart that illustrates another embodiment, specifically an exemplary method of freeze drying 100 that may be used with or without the membrane drying systems depicted in FIGS. 1A, 1B, 2A, 2B, and 3, or otherwise described above. First, a product is frozen as shown in step 101. Then, the pressure surrounding the product is reduced as shown in step 102. One mechanism by which pressure may be reduced is a vacuum pump, including but not limited to reducing the pressure sufficiently to create a vacuum around the product.

As or after the pressure surrounding the product is reduced, the product is warmed as shown in step 103. As the product is warmed, sweep gas is fed through a membrane dryer system that is attached to the chamber that the object is disposed within as shown in step 104. For the method to work most effectively, the warming the product step may not raise the temperature of the product up to or past the temperature at which frozen solvents within the product melt back into a liquid state. Sources of sweep gas are known to those of ordinary skill in the art and include, but are not limited to, a compressed air dryer, dry gas cylinder, other conventional or yet-to-be developed sweep gas sources, and/or any combinations thereof.

The exemplary membranes (e.g., membrane 16) shown and described above herein may comprise conventional gas separation membranes, as known to one of ordinary skill in the art.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

We claim:

1. A membrane drying system comprising:
a chamber;
a vacuum pump;
a sweep gas source; and
a membrane device, comprising
a membrane,
a first inlet in fluid communication with the chamber and the membrane,
a first outlet in fluid communication with the membrane and the vacuum pump,
a second inlet in fluid communication with the sweep gas source and the membrane, and
a second outlet in fluid communication with the membrane.

2. The membrane drying system of claim 1, further comprising a gas filtration system connected to the membrane device.

3. The membrane drying system of claim 1, further comprising a scrubber connected to the membrane device.

4. The membrane drying system of claim 3, wherein the scrubber is an activated carbon bed, activated alumina, hopcalite, a silica gel bed, or a refrigerated coil.

5. The membrane drying system of claim 1, wherein the second outlet is in fluid communication with a vent, an apparatus, or the atmosphere.

6. The membrane drying system of claim 1, wherein the membrane device is housed within the chamber.

7. The membrane drying system of claim 1, wherein the membrane device is attached externally to the chamber.

8. The membrane drying system of claim 1, wherein the sweep gas source feeds sweep gas through the membrane device in a direction that is concurrent with the direction of flow of gas from the chamber.

9. The membrane drying system of claim 1, wherein the sweep gas source feeds sweep gas through the membrane device in a direction that is countercurrent to the direction of flow of gas from the chamber.

10. The membrane drying system of claim 1, wherein the membrane is shell-encased, a hollow fiber membrane, a wrapped membrane, or a pleated membrane.

11. The membrane drying system of claim 1, wherein the membrane contains one or more layers of composites within the membrane fibers.

12. The membrane drying system of claim 1, wherein the sweep gas source is a compressed air dryer or a dry gas cylinder.

13. The membrane drying system of claim 1, wherein a sweep gas provided by the sweep gas source has a lower dewpoint than the gas within the chamber.

14. The membrane drying system of claim 1, further comprising a shelf disposed within the chamber.

15. The membrane drying system of claim 1, further comprising a freezer for freezing a product within the chamber.

16. The membrane drying system of claim 1, further comprising a heater for heating a product within the chamber.

17. The membrane drying system of claim 1, wherein the chamber is in fluid communication with a moist gas source.

18. A method of drying, comprising the steps of:
a. reducing the pressure surrounding a product within a chamber;
b. drawing a chamber gas into a membrane device;
c. feeding a sweep gas through a membrane device;
d. exhausting the sweep gas from the membrane device;
e. exhausting the chamber gas from the membrane device; and
f. warming a surface upon which the frozen object rests.

19. The method of claim 18, further comprising freezing the product.

20. The method of claim 18, further comprising filtering the gas.

21. The method of claim 18, further comprising scrubbing solvents.

22. The method of claim 18, further comprising venting solvents out of the membrane device.

23. The method of claim 18, wherein the feeding a sweep gas through a membrane device step comprises feeding a sweep gas in a direction that is concurrent with the direction of flow of the chamber gas.

24. The method of claim 18, wherein the feeding a sweep gas through a membrane device step comprises feeding a sweep gas in a direction that is countercurrent to the direction of flow of the chamber gas.

25. The method of claim 18, wherein the feeding a sweep gas through a membrane device step comprises feeding air from a compressed air dryer or from a dry gas cylinder.

26. An apparatus for drying comprising:
a chamber;
a vacuum pump;
a sweep gas source; and
a membrane device, comprising
a membrane,
a first inlet in fluid communication with the chamber and the membrane through which gas from the chamber enters the membrane,
a first outlet in fluid communication with the membrane and the vacuum pump through which gas from the chamber exits the membrane into the vacuum pump,
a second inlet in fluid communication with the sweep gas source and the membrane for directing sweep gas into the membrane, and
a second outlet in fluid communication with the membrane for directing the sweep gas out of the membrane.
